(19) United States
(12) Patent Application Publication
(10) Pub. No.: US 2026/0093201 A1
(43) Pub. Date: Apr. 2, 2026

(54) IMAGE FORMING APPARATUS, AND ABNORMALITY DETERMINATION METHOD

(71) Applicant: KYOCERA Document Solutions Inc., Osaka (JP)

(72) Inventor: Takuya Aritsuki, Osaka (JP)

(21) Appl. No.: 19/343,457

(22) Filed: Sep. 29, 2025

(30) Foreign Application Priority Data
Sep. 30, 2024 (JP) 2024-170819

(51) Int. Cl. G03G 15/00

(52) U.S. Cl. CPC G03G 15/70; G03G 15/6502; G03G 15/6558; G03G 2215/00717

(57) ABSTRACT

An image forming apparatus includes a drive motor, a transmission switching portion, a conveying processing portion, and an abnormality determination processing portion. The conveying processing portion drives the drive motor while the image forming portion is not executing an image forming process for forming an image on a sheet, and executes a lift raising process for switching the transmission switching portion to a transmission state in which the driving force of the drive motor is transmitted to the lift mechanism. The abnormality determination processing portion determines absence or presence of a sheet conveying abnormality on a conveying path along which the sheet is conveyed by the conveying rollers when the lift raising process is executed by the conveying processing portion without executing an image forming process in which an image is formed on the sheet by the image forming portion.

### INCORPORATION BY REFERENCE

The present application is based upon and claims the benefit of priority from the corresponding Japanese Patent Application No. 2024-170819 filed on September 30, 2024, the entire contents of which are incorporated herein by reference.

The present disclosure relates to an image forming apparatus and an abnormality determination method.

### BACKGROUND

In an image forming apparatus that executes an image forming process to form an image on a sheet, sheets placed on a sheet placement portion are fed in order from a top portion, and when the number of sheets placed on the sheet placement portion decreases, the sheet placement portion may be raised using a motor. In addition, in this type of image forming apparatus, a single motor can be used as a drive source for both conveying rollers used to convey the sheet and a lift mechanism that raises the sheet placement portion, thereby simplifying the configuration of the apparatus. More specifically, transmission of a driving force of a motor that drives the conveying rollers to the lift mechanism may be switched ON and OFF using a drive transmission portion such as an electromagnetic clutch.

### SUMMARY

An image forming apparatus according to one aspect of the present disclosure includes a drive motor, a transmission switching portion, a conveying processing portion, and an abnormality determination processing portion. The drive motor drives conveying rollers that convey a sheet fed from a sheet storing portion toward an image forming portion that forms an image on the sheet. The transmission switching portion switches between transmitting and not transmitting the driving force of the drive motor to a lift mechanism that raises sheets stored in the sheet storing portion. The conveying processing portion drives the drive motor while the image forming portion is not executing an image forming process for forming an image on a sheet, and executes a lift raising process that switches the transmission switching portion to a transmission state in which the driving force of the drive motor is transmitted to the lift mechanism. The abnormality determination processing portion determines presence or absence of a sheet conveying abnormality on a conveying path along which the sheet is conveyed by the conveying rollers when the lift raising process is executed by the conveying processing portion without executing an image forming process in which an image is formed on a sheet by the image forming portion.

An abnormality determination method according to another aspect of the present disclosure is a method in which one or a plurality of processors that control an image forming apparatus including a drive motor and a transmission switching portion execute a first step and a second step. The drive motor drives conveying rollers that convey a sheet fed from a sheet storing portion toward an image forming portion that forms an image on the sheet. The transmission switching portion switches between transmitting and not transmitting the driving force of the drive motor to a lift mechanism that raises sheets stored in the sheet storing portion. In the first step, while an image forming process for forming an image on a sheet is not being executed by the image forming portion, a lift raising process is executed in which the drive motor is driven and the transmission switching portion is switched to a transmission state in which the driving force of the drive motor is transmitted to the lift mechanism. In the second step, in a case in which the lift raising process is executed in the first step, presence or absence of a sheet conveying abnormality on a conveying path along which the sheet is conveyed by the conveying rollers is determined.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a configuration of an image forming apparatus of an embodiment according to the present disclosure.

FIG. 2 is a block diagram showing a configuration of an image forming apparatus of an embodiment according to the present disclosure.

FIG. 3 is a flowchart illustrating an example of a procedure of a conveying control process executed by an image forming apparatus of an embodiment according to the present disclosure.

FIG. 4 is a flowchart illustrating an example of a procedure of an abnormality determination process executed by an image forming apparatus of an embodiment according to the present disclosure.

### DETAILED DESCRIPTION

Hereinafter, embodiments according to the present disclosure will be described with reference to the accompanying drawings. The following embodiments are examples of a technique according to the present disclosure and do not limit the technical scope of the present disclosure.

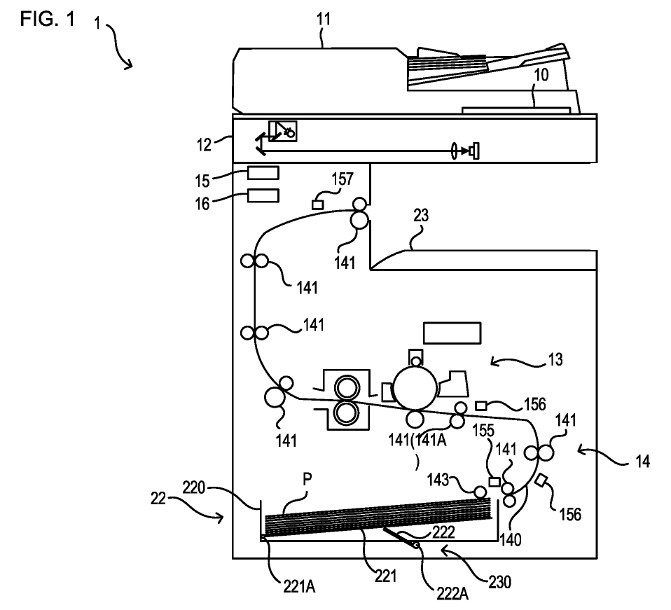

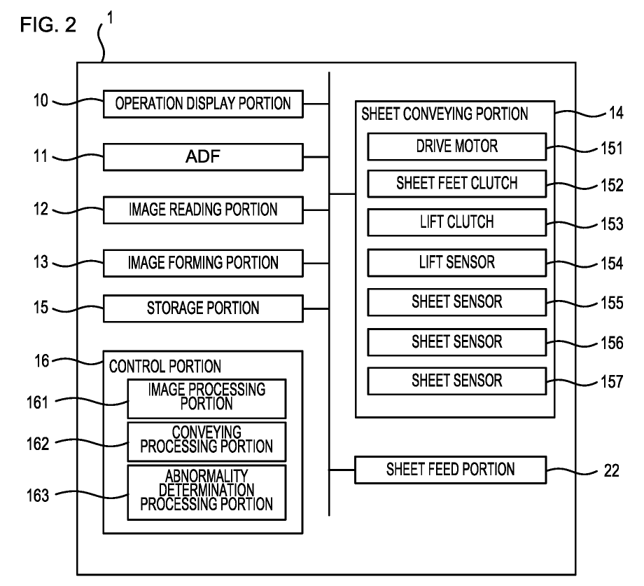

As shown in FIGS. 1 and 2, an image forming apparatus 1 according to the present embodiment includes an operation display portion 10, an automatic document feeder (ADF) 11, an image reading portion 12, an image forming portion 13, a sheet conveying portion 14, a storage portion 15, a control portion 16, a sheet feed portion 22, a sheet discharge portion 23, and the like. Note that the image forming apparatus 1 may include a plurality of sheet feed portions 22 or sheet discharge portions 23.

The image forming apparatus 1 is a multifunction peripheral having a printer function, a scanner function, a copy function, a facsimile function, and the like. Note that the present disclosure is not limited to a multifunction peripheral such as the image forming apparatus 1, and can be applied to any image forming apparatus such as a copier, a printer, or a facsimile machine. In addition, a device including the sheet conveying portion 14 and the control portion 16 is an example of a sheet conveying device according to the present disclosure.

The operation display portion 10 includes a display portion such as a liquid crystal display for displaying information, and an operation portion such as a touch panel for receiving user operations on the display portion. The ADF 11 is an automatic document feeder that includes a document setting portion, conveying rollers, a document holder, and a sheet discharge portion, and conveys documents to be read by the image reading portion 12. The image reading portion 12 includes a document table, a light source, a mirror, an optical lens, and a charge coupled device (CCD). The image reading portion 12 executes an image reading operation of reading an image of a document conveyed by the ADF 11 or a document set on the document table, and outputting the read image as document data.

The image forming portion 13 executes an image forming operation of forming an image based on document data on a sheet P that is conveyed from the sheet feed portion 22 by the sheet conveying portion 14 using electrophotography or an inkjet method. More specifically, in a case in which the image forming portion 13 is an electrophotographic image forming portion, the image forming portion 13 includes a photoconductor drum, a charging device, an exposure device, a developing device, a transfer device, a fixing device, and the like.

The sheet conveying portion 14 includes a conveying path 140, conveying rollers 141, a sheet feed roller 143, a drive motor 151, a sheet feed clutch 152, a lift clutch 153, a lift sensor 154, sheet sensors 155 to 157, and the like.

The conveying path 140 is a conveying path used to guide a sheet P from the sheet feed portion 22 via the image forming portion 13 to the sheet discharge portion 23. In the sheet conveying portion 14, the sheet P is conveyed from the sheet feed portion 22 to the image forming portion 13 via the conveying path 140, and then the sheet P after an image has been formed in the image forming portion 13 is conveyed toward the sheet discharge portion 23. Note that various types of electrical components provided in the sheet conveying portion 14 are electrically connected to the control portion 16 via a drive circuit (not shown) and the like and are controlled by the control portion 16.

The sheet feed portion 22 includes a sheet storing portion 220 that stores a sheet P on which an image is formed, a sheet placement portion 221, a lift member 222, and the like. Note that in the sheet feed portion 22, the sheet storing portion 220 is provided so as to be detachable or capable of being pulled out. For example, an attachment/detachment direction or a pull-out direction of the sheet storing portion 220 is a depth direction or a left-right direction of the sheet surface in FIG. 2.

Sheets P stored inside the sheet storing portion 220 are placed on the sheet placement portion 221. In addition, one end of the sheet placement portion 221 opposite to the conveying path 140 is rotatably supported by a rotation shaft 221A. A free end of the sheet placement portion 221 on the conveying path 140 side is supported by a bottom portion of the sheet storing portion 220 before the sheet storing portion 220 is attached to the sheet feed portion 22. When the sheet storing portion 220 is attached to the sheet feed portion 22, the bottom portion of the sheet placement portion 221 is supported by the lift member 222 provided in the sheet feed portion 22. The lift member 222 is rotatably supported by a rotation shaft 222A.

The rotation shaft 222A is connected to a drive shaft of the drive motor 151 via the lift clutch 153 and a gear (not shown). When the rotation shaft 222A rotates and the lift member 222 rotates, an end of the sheet placement portion 221 on the conveying path 140 side is raised. In the present embodiment, a lift mechanism 230 that raises the sheets P stored in the sheet storing portion 220 is configured by the sheet placement portion 221, the lift member 222, the rotation shaft 222A, and the like. The lift mechanism 230 is driven by a driving force transmitted from the drive motor 151 to the rotation shaft 222A.

Each of the conveying rollers 141 is provided along the conveying path 140 and is a pair of rollers that rotate by the driving force transmitted from the drive motor 151. For example, the conveying rollers 141 include conveying rollers that convey the sheet P from the sheet feed portion 22 along the conveying path 140 toward the image forming portion 13, and conveying rollers that convey the sheet P from the image forming portion 13 along the conveying path 140 toward the sheet discharge portion 23. In addition, the conveying rollers 141 also include a registration roller 141A that is connected to the drive motor 151 via a drive transmission portion such as a clutch (not shown). A conveying processing portion 162, described later, by controlling the drive transmission portion, switches between transmitting and not transmitting the driving force from the drive motor 151 to the registration roller 141A, and controls timing of conveying the sheet P conveyed along the conveying path 140 to the image forming portion 13.

The sheet feed roller 143 is rotatably supported by a housing of the image forming apparatus 1 above the sheet storing portion 220. In addition, the sheet feed roller 143 is biased downward by an elastic member (not shown), and is pressed against a top sheet P placed on the sheet placement portion 221 of the sheet storing portion 220 when the top sheet P is in a predetermined position. The sheet feed roller 143 is connected to the drive shaft of the drive motor 151 via the sheet feed clutch 152 and a gear (not shown). The sheet feed roller 143 rotates by the driving force transmitted from the drive motor 151, and feeds sheets P stored in the sheet storing portion 220 one by one toward the conveying rollers 141 of the conveying path 140.

The drive motor 151 is a drive source used to drive the conveying rollers 141, the sheet feed roller 143, and the lift mechanism 230. Note that in the present embodiment, the conveying rollers 141, the sheet feed roller 143, and the lift mechanism 230 are driven by a single drive motor; however, in other embodiments, at least the sheet feed roller 143 and the lift mechanism 230 may be driven by a single drive motor. In other words, the conveying rollers 141 may be driven by a drive motor different from that of the sheet feed roller 143 and the lift mechanism 230.

The sheet feed clutch 152 is a first transmission switching portion that switches between transmitting and not transmitting the driving force of the drive motor 151 to the sheet feed roller 143 under the control of the control portion 16. More specifically, the sheet feed clutch 152 is an electromagnetic clutch that can be switched between a transmission state in which the driving force of the drive motor 151 is transmitted to the sheet feed roller 143 and a non-transmission state in which the driving force of the drive motor 151 is not transmitted to the sheet feed roller 143.

The lift clutch 153 is a second transmission switching portion that is controlled by the control portion 16 to switch between transmitting and not transmitting the driving force of the drive motor 151 to the lift mechanism 230. More specifically, the lift clutch 153 is an electromagnetic clutch that can be switched between a non-transmission state in which the driving force of the drive motor 151 is not transmitted to the lift mechanism 230 and a transmission state in which the driving force of the drive motor 151 is transmitted to the lift mechanism 230.

The lift clutch 153 includes a ratchet mechanism that restricts rotation in a direction opposite to a rotation direction of the rotation shaft 222A by the drive of the drive motor 151. By restricting the rotation of the lift clutch 153 in the reverse direction, the rotation in the reverse direction of the rotation shaft 222A engaged with the lift clutch 153 is also restricted, and downward movement of the sheet placement portion 221 due to its own weight is restricted. Note that when the sheet storing portion 220 is pulled out from the sheet feed portion 22, the connection between the rotation shaft 222A and the lift clutch 153 is released. Thus, the restriction on the rotation of the rotation shaft 222A in the reverse direction by the lift clutch 153 is released, the sheet placement portion 221 descends under its own weight, and the lift member 222 also descends to a predetermined initial position.

When the control portion 16 drives the drive motor 151 and switches the lift clutch 153 from the non-transmission state to the transmission state, the driving force of the drive motor 151 is transmitted to the rotation shaft 222A, causing the lift member 222 to rotate in a predetermined direction. Thus, an inclination angle of the sheet placement portion 221 is changed by the lift member 222. More specifically, by the lift member 222 rotating clockwise in FIG. 1, the sheet placement portion 221 rotates counterclockwise about the rotation shaft 221A and is raised.

The lift sensor 154 detects that the sheet P in the sheet storing portion 220 has risen and the sheet feed roller 143 has been pressed upward. The lift sensor 154 is used to measure timing for switching the lift clutch 153 from the transmission state to the non-transmission state (stopping the raising of the sheet placement portion 221).

More specifically, when the sheet storing portion 220 is attached to the sheet feed portion 22, the control portion 16 drives the drive motor 151 and switches the lift clutch 153 from the non-transmission state to the transmission state. Thus, the driving force of the drive motor 151 is transmitted to the rotation shaft 222A, and the sheet placement portion 221 is raised. After that, in a case in which the lift sensor 154 detects that the sheet feed roller 143 is pressed, the control portion 16 switches the lift clutch 153 from the transmission state to the non-transmission state. Thus, the transmission of the driving force of the drive motor 151 to the rotation shaft 222A is interrupted, and the raising of the sheet placement portion 221 is stopped. When the sheet P at the top portion of the sheet placement portion 221 is pressed against the sheet feed roller 143 in this manner, the sheet P is ready to be fed toward the conveying path 140 by the drive of the sheet feed roller 143.

In addition, when the image forming portion 13 performs an image forming operation, the control portion 16 controls the sheet conveying portion 14 and the sheet feed portion 22 to convey the sheet P from the sheet storing portion 220 of the sheet feed portion 22 to the image forming portion 13. When the image forming operation by the image forming portion 13 on one sheet P is completed, even in a case in which the predetermined condition for raising the sheet placement portion 221 is satisfied, the control portion 16 drives the drive motor 151 and switches the lift clutch 153 from the non-transmission state to the transmission state in order to raise the sheet placement portion 221. After that, in a case in which the lift sensor 154 detects that the sheet feed roller 143 is pressed, the control portion 16 switches the lift clutch 153 from the transmission state to the non-transmission state. Thus, the transmission of the driving force of the drive motor 151 to the rotation shaft 222A is interrupted, and the raising of the sheet placement portion 221 is stopped.

The sheet sensors 155 to 157 are detection portions that detect a presence or absence of an object such as a sheet P at each arrangement position. For example, the sheet sensors 155 to 157 are optical sensors that include a light emitting portion and a light receiving portion. In addition, the sheet sensors 155 to 157 may be configured using contact-type switches. Note that the results of detection of the presence or absence of the sheet P by each of the sheet sensors 155 to 157 are input to the control portion 16 and used to detect the position of the sheet P or to detect a jam.

More specifically, the sheet sensor 155 is provided between the sheet feed roller 143 and the conveying rollers 141 at a position where the sheet sensor 155 can detect the sheet P fed from the sheet feed roller 143. The sheet sensor 156 is provided at one or more positions on the conveying path 140 at which the sheet P passing through the conveying path 140 can be detected. The sheet sensor 157 is provided between the image forming portion 13 and the sheet discharge portion 23 at a position where the sheet sensor 157 can detect the sheet P discharged to the sheet discharge portion 23.

The storage portion 15 is a non-volatile storage portion such as a hard disk. For example, the storage portion 15 stores an image forming program for causing the control portion 16 to execute various types of processes such as an image forming process described below.

The control portion 16 is a computer system including a CPU, a ROM, a RAM, and the like, and controls the operation of the image forming apparatus 1. The CPU is a processor that executes various types of arithmetic processing. The ROM is a non-volatile storage portion in which information such as control programs for causing the CPU to execute various types of processes is stored in advance. The RAM is a volatile or non-volatile storage portion used as a temporary storage memory (work area) for various types of processes executed by the CPU.

In a configuration in which the transmission of the driving force of the motor that drives the conveying rollers to the lift mechanism can be switched using a drive transmission portion, the conveying rollers are also driven when the lift mechanism is driven. Therefore, even when an image forming process is not being executed, when the lift mechanism is driven, there is a risk of sheet conveying abnormalities, such as unintended conveying of foreign objects such as sheet fragments or sheet jams, occurring on the conveying path along which the sheet is conveyed by the conveying rollers. In response to this, as will be described below, a single motor can be used for both the conveying rollers and the lift mechanism, simplifying the configuration of the apparatus while making it possible to detect sheet conveying abnormalities even when an image forming process is not being executed.

More specifically, in the image forming apparatus 1 according to the present embodiment, as shown in FIG. 2, the control portion 16 includes various types of processing portions such as an image processing portion 161, a conveying processing portion 162, and an abnormality determination processing portion 163. The control portion 16 executes various types of processes in accordance with the image forming program stored in the storage portion 15, thereby functioning as the various types of processing portions. In addition, the control portion 16 may include one or a plurality of electronic circuits that achieve some or all of the functions of the various types of processing portions. Furthermore, the control portion 16 may include a plurality of processors, and function as the various types of processing portions by each of the processors executing various types of processes.

The image processing portion 161 controls the image forming portion 13 and is capable of executing an image forming process for printing an image corresponding to document data that is input from an external device such as a personal computer or document data stored in the storage portion 15 onto a sheet. Note that the image processing portion 161 is also capable of controlling the image reading portion 12 to execute an image reading process for reading an image from a document set on the document table or the ADF 11 or the like.

The conveying processing portion 162 controls the drive motor 151, the sheet feed clutch 152, the lift clutch 153, and the like, to control the conveying of the sheet P on which an image is formed in the image forming process. In particular, the conveying processing portion 162 switches the lift clutch 153 from the non-transmission state to the transmission state while the driving force of the drive motor 151 is not being transmitted to the sheet feed roller 143 by the sheet feed clutch 152. In other words, in a state in which the driving force of the drive motor 151 is transmitted to the sheet feed roller 143 by the sheet feed clutch 152, the conveying processing portion 162 restricts the lift clutch 153 from switching from the non-transmission state to the transmission state. In other words, the conveying processing portion 162 does not generate a state in which the driving force of the drive motor 151 is transmitted to both the sheet feed roller 143 and the lift mechanism 230.

In addition, even when the image forming process is not being executed by the image processing portion 161, the conveying processing portion 162 may drive the drive motor 151 and execute a lift raising process to switch the lift clutch 153 to a transmission state in which the driving force of the drive motor 151 is transmitted to the lift mechanism 230. For example, as described above, when the sheet storing portion 220 is attached to the sheet feed portion 22 of the image forming apparatus 1, the lift raising process is executed. In addition, the conveying processing portion 162 may execute the lift raising process when the image forming apparatus 1 is turned ON or when the image forming apparatus 1 returns from a power saving mode.

In a case in which the conveying processing portion 162 executes the lift raising process, the abnormality determination processing portion 163 determines a presence or absence of a sheet conveying abnormality on the conveying path 140 along which the sheet is conveyed by the conveying rollers 141. The abnormality determination processing portion 163 executes a specific notification process in a case in which it is determined that a sheet conveying abnormality has occurred. More specifically, in a case in which the lift raising process is executed and the sheet sensors 155 to 157 detect the presence of an object on the conveying path 140, the abnormality determination processing portion 163 determines that a sheet conveying abnormality has occurred.

### Conveying Control Process

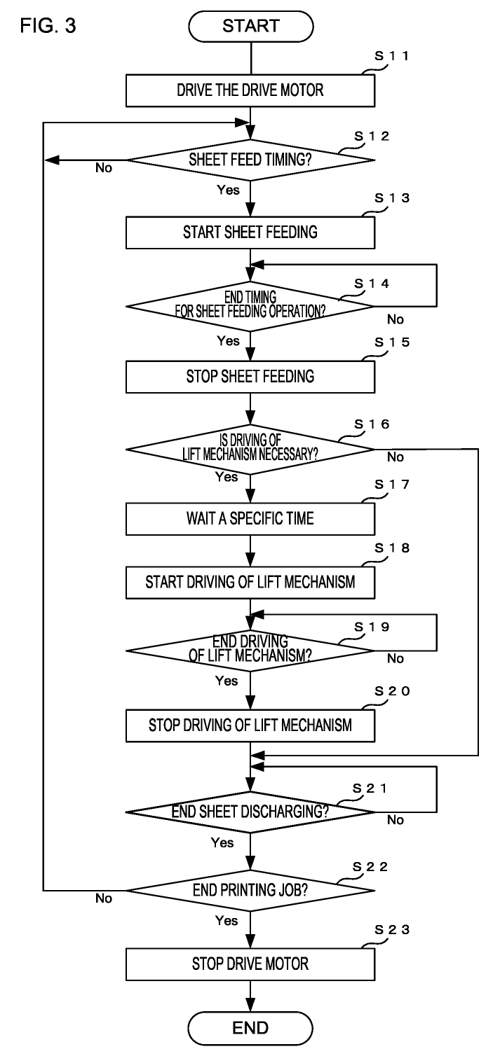

First, an example of a procedure of a conveying control process executed by the control portion 16 in accordance with the image forming program will be described with reference to FIG. 3. Here, steps S11, S12, and so on represent numbers of processing procedures (steps) executed by the control portion 16. Note that the processing procedures in the conveying control process may be executed in parallel as long as similar processing results are obtained.

The conveying control process is executed by the conveying processing portion 162 when a request to execute a printing job based on document data occurs in the image forming apparatus 1 and the image forming process is executed by the image processing portion 161.

### Step S11

In step S11, the conveying processing portion 162 starts driving the drive motor 151 to cause each of the conveying rollers 141 to start rotating. At this time, the conveying processing portion 162 does not drive the sheet feed clutch 152 and the lift clutch 153, the sheet feed clutch 152 is in the non-transmission state in which the sheet feed roller 143 is not driven, and the lift clutch 153 is in the non-transmission state in which the lift mechanism 230 is not driven. Note that the timing for starting driving by the drive motor 151 may be in step S13 described later.

### Step S12

In step S12, the conveying processing portion 162 determines whether or not timing for starting the sheet feeding operation has arrived. More specifically, the conveying processing portion 162 determines that the sheet feed timing has arrived when a preset sheet conveying start timing in the image forming process executed by the image processing portion 161 has arrived. When it is determined that the sheet feed timing has arrived (S12: Yes), the process proceeds to step S13, and the process waits in step S12 until it is determined that the sheet feed timing has arrived (S12: No).

### Step S13

In step S13, the conveying processing portion 162 switches the sheet feed clutch 152 from the non-transmission state to the transmission state. Thus, the driving force of the drive motor 151 is transmitted to the sheet feed roller 143 via the sheet feed clutch 152, and the sheet feed roller 143 starts to feed the sheet P from the sheet storing portion 220.

### Step S14

In step S14, the conveying processing portion 162 determines whether or not it is time to end the sheet feeding operation. More specifically, when the sheet P is detected by the sheet sensor 155 and then the sheet P is no longer detected, the conveying processing portion 162 determines that it is time to end the sheet feeding operation. In addition, the conveying processing portion 162 may determine that it is time to end the sheet feeding operation when a sheet feeding time preset in accordance with the size of the sheet P has elapsed since the start of feeding of the sheet P in step S13.

### Step S15

In step S15, the conveying processing portion 162 switches the sheet feed clutch 152 from the transmission state to the non-transmission state. Thus, the driving force of the drive motor 151 is no longer transmitted to the sheet feed roller 143 via the sheet feed clutch 152, and the sheet feed roller 143 stops.

However, even when the sheet feed clutch 152 is switched to the non-transmission state, the transmission of the driving force of the drive motor 151 to the sheet feed roller 143 is not immediately cut off, and there may be a period of time during which the transmission of the driving force of the drive motor 151 to the sheet feed roller 143 continues. Note that a time lag between when the sheet feed clutch 152 is switched to the non-transmission state and when the driving force of the drive motor 151 is no longer transmitted to the sheet feed roller 143 can be known or estimated in advance based on the specifications or type of the sheet feed clutch 152, and the like. In the image forming apparatus 1, a time corresponding to the time lag is set as a specific time, and is used as a waiting time for processing in step S17 described later.

### Step S16

In step S16, the conveying processing portion 162 determines whether or not it is necessary to drive the lift mechanism 230. More specifically, in a case in which the lift sensor 154 detects that the sheet feed roller 143 is being pressed upward, the conveying processing portion 162 determines that it is not necessary to drive the lift mechanism 230. In addition, in a case in which the lift sensor 154 does not detect that the sheet feed roller 143 is being pressed upward, the conveying processing portion 162 determines that it is necessary to drive the lift mechanism 230. When it is determined that driving of the lift mechanism 230 is necessary (S16: Yes), the process proceeds to step S17, and when it is determined that driving of the lift mechanism 230 is not necessary (S16: No), the process proceeds to step S21. Note that the conveying processing portion 162 may determine that it is necessary to drive the lift mechanism 230 when a preset number of sheets P have been fed from the sheet storing portion 220.

### Step S17

In step S17, the conveying processing portion 162 starts measuring the preset specific time, and after the specific time has elapsed, the process proceeds to step S18. Thus, the switching of the lift clutch 153 in step S18 described below is executed after waiting for at least the specific time after the sheet feed clutch 152 is switched to the non-transmission state in step S15. Note that in another embodiment, instead of waiting for the specific time, based on the detection result by a detection portion that detects whether or not the sheet feed roller 143 is rotating, in a case in which the sheet feed roller 143 is stopped, it may be determined that the driving force of drive motor 151 is no longer being transmitted to sheet feed roller 143, and the process may proceed to step S18.

### Step S18

In step S18, the conveying processing portion 162 starts driving the lift mechanism 230 by switching the lift clutch 153 from the non-transmission state to the transmission state. That is, the driving force of the drive motor 151 is transmitted to the rotation shaft 222A of the lift mechanism 230 via the lift clutch 153, the lift mechanism 230 is driven, and the sheets P start to be raised. Note that in another embodiment, in steps S17 to S18, the conveying processing portion 162 may start driving the lift mechanism 230 by switching the lift clutch 153 from the non-transmission state to the transmission state at a timing after a preset time equal to or greater than the specific time has elapsed from the timing at which the registration roller 141A starts to be driven (the timing at which secondary sheet feeding starts).

### Step S19

In step S19, the conveying processing portion 162 determines whether or not to end the driving of the lift mechanism 230. More specifically, the conveying processing portion 162 determines not to end the driving of the lift mechanism 230 until the lift sensor 154 detects that the sheet feed roller 143 has been pressed upward. In addition, in a case in which the lift sensor 154 detects that the sheet feed roller 143 has been pressed upward, the conveying processing portion 162 determines to end the driving of the lift mechanism 230. When it is determined that the driving of the lift mechanism 230 is to be ended (S19: Yes), the process proceeds to step S20, and the process waits in step S19 until it is determined that the driving of the lift mechanism 230 is to be ended (S19: No).

In addition, in step S19, the conveying processing portion 162 may determine to end the driving of the lift mechanism 230 in a case in which a preset raising time has elapsed after the driving of the lift mechanism 230 was started in step S18 (S19: Yes). In this case, it is considered that the conveying processing portion 162 sets the raising time based on either or both of the rotation speed of the drive motor 151 and the thickness of the sheet P stored in the sheet storing portion 220.

More specifically, the conveying processing portion 162 may change the rotation speed of the conveying rollers 141 by changing the rotation speed of the drive motor 151 according to the thickness of the sheet P conveyed by the conveying rollers 141. When the rotation speed of the drive motor 151 changes in this manner, the rotation speed of the rotation shaft 222A in the lift mechanism 230 also changes. Therefore, it is conceivable that the conveying processing portion 162 will set the raising time to be shorter as the rotation speed of the drive motor 151 becomes faster, and will set the raising time to be longer as the rotation speed of the drive motor 151 becomes slower. Thus, it is possible to maintain the same amount that the sheets P are raised by the lift mechanism 230 during the raising time even when the rotation speed of the drive motor 151 changes.

In addition, the time it takes for the sheet P placed on the top portion of the sheet placement portion 221 to press against the sheet feed roller 143 due to the driving of the lift mechanism 230 varies depending on the thickness of the sheets P stored in the sheet storing portion 220. Therefore, it is conceivable that the conveying processing portion 162 will set the raising time to a shorter value the thinner the sheets P stored in the sheet storing portion 220 become, and will set the raising time to a longer value the thicker the sheets P stored in the sheet storing portion 220 become. Thus, even in a case in which the thickness of the sheets P stored in the sheet storing portion 220 is different, it is possible to make the amount of raising of the sheets P by the lift mechanism 230 during the lifting time the same. Note that the thickness of the sheets P stored in the sheet storing portion 220 is set according to the sheet type (plain paper, thick paper, or the like) selected in the initial settings of the image forming apparatus 1, for example.

Here, a case has been described in which the raising time is appropriately set as the time during which the lift mechanism 230 is driven. On the other hand, in other embodiments, in the image forming apparatus 1, the start timing of the image forming process for each sheet P executed by the image processing portion 161 or the start timing of conveying of each sheet P may be determined based on either or both of the rotation speed of the drive motor 151 and the thickness of the sheet P stored in the sheet storing portion 220. More specifically, the image processing portion 161 may determine the timing to start the image forming process for the next sheet P after the image forming process for one sheet P is completed based on either or both of the rotation speed of the drive motor 151 and the thickness of the sheet P stored in the sheet storing portion 220. For example, in a case in which the image forming portion 13 is an electrophotographic image forming portion, the timing for starting the image forming process for the next sheet P is the timing for starting a process of forming an electrostatic latent image corresponding to an image to be formed on the sheet P on the photoconductor drum.

### Step S20

In step S20, the conveying processing portion 162 stops driving the lift mechanism 230 by switching the lift clutch 153 from the transmission state to the non-transmission state. That is, the driving force of the drive motor 151 is no longer transmitted to the rotation shaft 222A via the lift clutch 153, the driving of the lift mechanism 230 stops, and the raising of the sheets P stops.

### Step S21

In step S21, the conveying processing portion 162 determines whether or not the sheet P that is the target of the image forming process has been discharged to the sheet discharge portion 23. More specifically, the conveying processing portion 162 determines that the sheet P has been discharged when a preset time has elapsed since the sheet P was detected by the sheet sensor 157 and is no longer detected by the sheet sensor 157. In addition, the conveying processing portion 162 may determine that the sheet P has been discharged when a preset time has elapsed since feeding of the sheet P from the sheet storing portion 220 was started. When it is determined that the sheet P has been discharged (S21: Yes), the process proceeds to step S22, and the process waits in step S21 until the sheet P is discharged (S21: No).

### Step S22

In step S22, the conveying processing portion 162 determines whether or not the printing job is completed. More specifically, in a case in which the printing job includes an image forming operation on a plurality of sheets P, it is determined that the printing job is completed when the image forming operation on all of the sheets P is completed. When it is determined that the printing job has been completed (S22: Yes), the process proceeds to step S23, and when it is determined that the printing job has not been completed (S22: No), the process returns to step S12.

### Step S23

In step S23, the conveying processing portion 162 stops driving by the drive motor 151, thereby causing the conveying rollers 141 to stop rotating.

### Abnormality Determination Process

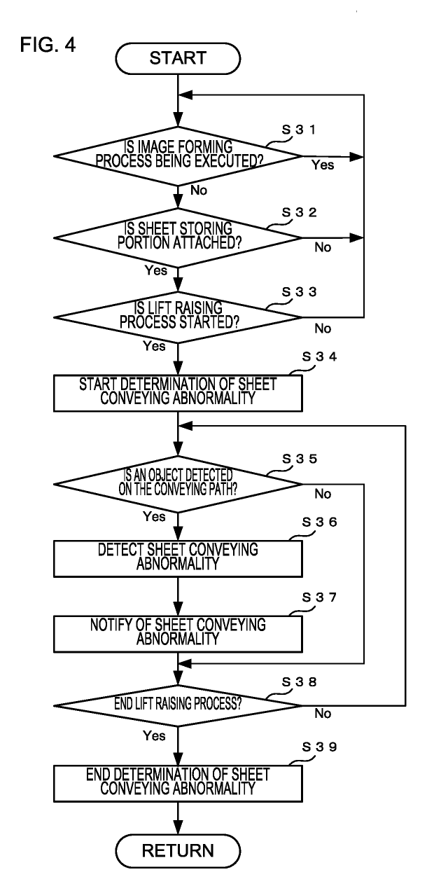

Next, an example of a procedure of an abnormality determination process executed by the control portion 16 in accordance with the image forming program will be described with reference to FIG. 4. Here, steps S31, S32, and so on represent numbers of processing procedures (steps) executed by the control portion 16. Note that the processing steps in the abnormality determination process may be executed in parallel as long as similar processing results are obtained.

The abnormality determination process is executed by an abnormality determination processing portion 163 of the control portion 16 when the image forming apparatus 1 is powered on. Note that the present disclosure may be regarded as an abnormality determination method in which a processor such as the control portion 16 conveys the sheet P by executing one or a plurality of steps in the abnormality determination process.

### Step S31

In step S31, the abnormality determination processing portion 163 determines whether or not the image forming process is being executed by the image processing portion 161. When it is determined that the image forming process is not being executed (S31: No), the process proceeds to step S32, and when it is determined that the image forming process is being executed (S31: Yes), the process waits in step S31.

### Step S32

In step S32, the abnormality determination processing portion 163 determines whether or not the sheet storing portion 220 is attached to the image forming apparatus 1 based on a detection result of an attachment detection sensor of the sheet storing portion 220. When it is determined that the sheet storing portion 220 is attached (S32: Yes), the process proceeds to step S33, and when it is determined that the sheet storing portion 220 is not attached (S32: No), the process returns to step S31. Note that in other embodiments, step S32 may be omitted.

### Step S33

In step S33, the abnormality determination processing portion 163 determines whether or not the lift raising process for driving the lift mechanism 230 is started by the conveying processing portion 162. That is, the abnormality determination processing portion 163 determines whether or not to start the driving of each of the conveying rollers 141 by driving the lift mechanism 230. When it is determined that the lift raising process is to be started (S33: Yes), the process proceeds to step S34, and when it is determined that the lift raising process is not to be started (S33: No), the process returns to step S31.

### Step S34

In step S34, the abnormality determination processing portion 163 starts a sheet conveying abnormality determination process for determining whether or not a sheet conveying abnormality has occurred based on detection results of the sheet sensors 155 to 157.

### Step S35

In step S35, the abnormality determination processing portion 163 determines whether or not an object present on the conveying path 140 has been detected by any of the sheet sensors 155 to 157. When it is determined that an object is detected by any of the sheet sensors 155 to 157 (S35: Yes), the process proceeds to step S36, and when it is determined that an object is not detected by any of the sheet sensors 155 to 157 (S35: No), the process proceeds to step S38.

### Step S36

In step S36, the abnormality determination processing portion 163 determines that a sheet conveying abnormality has occurred. That is, the abnormality determination processing portion 163 detects the occurrence of a sheet conveying abnormality even when the image forming process is not being performed, the sheet storing portion 220 is attached to the sheet feed portion 22, and the lift mechanism 230 is operating.

### Step S37

In step S37, in a case in which it is determined in step S36 that a sheet conveying abnormality has occurred, the abnormality determination processing portion 163 executes a notification process to notify the user of the occurrence of the sheet conveying abnormality by displaying the occurrence of the sheet conveying abnormality on the operation display portion 10. Note that in the notification process, the occurrence of the sheet conveying abnormality may be notified to a notification destination such as a mobile terminal or personal computer of the user that has been preset. Furthermore, in the notification process, the abnormality determination processing portion 163 may notify a location of the occurrence of the sheet conveying abnormality in response to a sheet sensor among the sheet sensors 155 to 157 that detects an object present on the conveying path 140.

### Step S38

In step S38, the abnormality determination processing portion 163 determines whether or not the conveying processing portion 162 has completed the lift raising process. That is, the abnormality determination processing portion 163 determines whether or not the driving of each of the conveying rollers 141 has stopped due to the stopping of the driving of the lift mechanism 230. When it is determined that the lift raising process has been completed (S38: Yes), the process proceeds to step S39, and when it is determined that the lift raising process has not been completed (S38: No), the process returns to step S35.

### Step S39

In step S39, the abnormality determination processing portion 163 ends the sheet conveying abnormality determination process started in step S34, and returns the process to step S31.

As described above, in the image forming apparatus 1, a sheet conveying abnormality can be detected even during a period in which the conveying rollers 141 are driven by the lift mechanism 230, not during the execution of the image forming process. Therefore, in the image forming apparatus 1, a single drive motor 151 is used for both the conveying rollers 141 and the lift mechanism 230, thereby simplifying the configuration of the apparatus, while making it possible to detect sheet conveying abnormalities even when the image forming process is not being executed. Thus, the user is able to prevent problems such as abnormal conveying of the sheet P in the image forming process that is executed after the occurrence of a sheet conveying abnormality when the lift mechanism 230 is driven, for example.

### Supplementary Notes

Below, a summary of the disclosure extracted from the above-described embodiments will be added. The configurations and processing functions described in the following supplementary notes can be selected and combined as desired.

### Supplementary Note 1

An image forming apparatus includes: a drive motor configured to drive conveying rollers that convey a sheet fed from a sheet storing portion toward an image forming portion that forms an image on the sheet; a transmission switching portion configured to switch between transmission and non-transmission of a driving force of the drive motor to a lift mechanism that raises sheets stored in the sheet storing portion; a conveying processing portion configured to execute a lift raising process of driving the drive motor and switching the transmission switching portion to a transmission state in which a driving force of the drive motor is transmitted to the lift mechanism while an image forming process for forming an image on a sheet is not being executed by the image forming portion; and an abnormality determination processing portion configured to determine a presence or absence of a sheet conveying abnormality on a conveying path along which a sheet is conveyed by the conveying rollers in a case in which the lift raising process is executed by the conveying processing portion in a state in which an image forming process for forming an image on a sheet is not executed by the image forming portion.

### Supplementary Note 2

The image forming apparatus according to Supplementary Note 1, wherein the abnormality determination processing portion determines presence or absence of a sheet conveying abnormality in a case in which the sheet storing portion is attached to the image forming apparatus.

### Supplementary Note 3

The image forming apparatus according to Supplementary Notes 1 or 2, wherein the abnormality determination processing portion executes a specific notification process in a case in which it is determined that the sheet conveying abnormality has occurred.

### Supplementary Note 4

The image forming apparatus according to any one of Supplementary Notes 1 to 3, further includes a detection portion configured to detect a presence or absence of an object on the conveying path, wherein the abnormality determination processing portion determines that the sheet conveying abnormality has occurred in a case in which the detection portion detects the presence of an object on the conveying path in a case in which the lift raising process is executed.

### Supplementary Note 5

The image forming apparatus according to any one of Supplementary Notes 1 to 4, further includes: a first transmission switching portion configured to switch between transmission and non-transmission of the driving force of the drive motor to a sheet feed roller that feeds sheets stored in the sheet storing portion toward the conveying rollers; wherein the conveying processing portion, in a state in which the driving force of the drive motor is not transmitted to the sheet feed roller by the first transmission switching portion, switches the transmission switching portion from a non-transmission state in which the driving force of the drive motor is not transmitted to the lift mechanism to a transmission state in which the driving force of the drive motor is transmitted to the lift mechanism.

### Supplementary Note 6

An abnormality determination method, wherein one or a plurality of processors for controlling an image forming apparatus including: a drive motor configured to drive conveying rollers that convey a sheet fed from a sheet storing portion toward an image forming portion that forms an image on the sheet; and a transmission switching portion configured to switch between transmission and non-transmission of a driving force of the drive motor to a lift mechanism that raises sheets stored in the sheet storing portion, executes: a first step of executing a lift raising process of driving the drive motor and switching the transmission switching portion to a transmission state in which the driving force of the drive motor is transmitted to the lift mechanism in a state in which an image forming process for forming an image on a sheet is not being executed by the image forming portion; and a second step of determining a presence or absence of a sheet conveyance abnormality on a conveying path along which the sheet is conveyed by the conveying rollers when the lift raising process is executed by the first step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a drive motor configured to drive conveying rollers that convey a sheet fed from a sheet storing portion toward an image forming portion that forms an image on the sheet;
a transmission switching portion configured to switch between transmission and non-transmission of a driving force of the drive motor to a lift mechanism that raises sheets (P) stored in the sheet storing portion;
a conveying processing portion configured to execute a lift raising process of driving the drive motor and switching the transmission switching portion to a transmission state in which a driving force of the drive motor is transmitted to the lift mechanism while an image forming process for forming an image on a sheet is not being executed by the image forming portion; and
an abnormality determination processing portion configured to determine a presence or absence of a sheet conveying abnormality on a conveying path along which a sheet is conveyed by the conveying rollers in a case in which the lift raising process is executed by the conveying processing portion in a state in which an image forming process for forming an image on a sheet is not executed by the image forming portion.

2. The image forming apparatus according to claim 1, wherein
the abnormality determination processing portion determines presence or absence of a sheet conveying abnormality in a case in which the sheet storing portion is attached to the image forming apparatus.

3. The image forming apparatus according to claim 1, wherein
the abnormality determination processing portion executes a specific notification process in a case in which it is determined that the sheet conveying abnormality has occurred.

4. The image forming apparatus according to claim 1, further comprising
a detection portion configured to detect a presence or absence of an object on the conveying path, wherein
the abnormality determination processing portion determines that the sheet conveying abnormality has occurred in a case in which the detection portion detects the presence of an object on the conveying path in a case in which the lift raising process is executed.

5. The image forming apparatus according to claim 1, further comprising
a first transmission switching portion configured to switch between transmission and non-transmission of the driving force of the drive motor to a sheet feed roller that feeds sheets stored in the sheet storing portion toward the conveying rollers; wherein
the conveying processing portion, in a state in which the driving force of the drive motor is not transmitted to the sheet feed roller by the first transmission switching portion, switches the transmission switching portion from a non-transmission state in which the driving force of the drive motor is not transmitted to the lift mechanism to a transmission state in which the driving force of the drive motor is transmitted to the lift mechanism.

6. An abnormality determination method, wherein
one or a plurality of processors for controlling an image forming apparatus including: a drive motor configured to drive conveying rollers that convey a sheet fed from a sheet storing portion toward an image forming portion that forms an image on the sheet; and a transmission switching portion configured to switch between transmission and non-transmission of a driving force of the drive motor to a lift mechanism that raises sheets stored in the sheet storing portion, executes:
a first step of executing a lift raising process of driving the drive motor and switching the transmission switching portion to a transmission state in which the driving force of the drive motor is transmitted to the lift mechanism in a state in which an image forming process for forming an image on a sheet is not being executed by the image forming portion; and
a second step of determining a presence or absence of a sheet conveyance abnormality on a conveying path along which the sheet is conveyed by the conveying rollers when the lift raising process is executed by the first step.
